(19) United States
(12) Patent Application Publication
(10) Pub. No.: US 2023/0328755 A1
(43) Pub. Date: Oct. 12, 2023

(54) METHOD AND DEVICE FOR TCI STATE INDICATION AND APPLICATION

(71) Applicant: GUANGDONG OPPO MOBILE TELECOMMUNICATIONS CORP., LTD., Dongguan (CN)

(72) Inventor: Li GUO, Allen, TX (US)

(21) Appl. No.: 18/147,321

(22) Filed: Dec. 28, 2022

Related U.S. Application Data
(63) Continuation of application No. PCT/CN2021/102838, filed on Jun. 28, 2021.
(60) Provisional application No. 63/075,902, filed on Sep. 9, 2020.

(51) Int. Cl. H04W 72/232; H04W 16/28; H04B 7/06; H04W 72/1273

(52) U.S. Cl. CPC H04W 72/232; H04W 16/28; H04B 7/06968; H04W 72/1273

(57) ABSTRACT

Methods and devices for transmission configuration indicator (TCI) state indication and application are provided. The method includes: a terminal device receives configuration of one or more TCI states from a network device; the terminal device receives indication of a TCI state through downlink control information (DCI) from the network device, wherein the indicated TCI state includes quasi co-location (QCL) information for downlink reception and includes information for determining a spatial filter and/or a path loss reference signal for uplink transmission; and the terminal device applies the QCL information in the indicated TCI state to downlink reception and applies the information for determining a spatial filter and/or a path loss reference signal in the indicated TCI state to uplink transmission, starting from a pre-defined time point.

### CROSS-REFERENCE TO RELATED APPLICATION(S)

The present application is a continuation application of International PCT Application No. PCT/CN2021/102838, filed on Jun. 28, 2021, which claims priority of U.S. provisional patent application No. 63/075,902, filed on Sep. 9, 2020. The above-identified applications are incorporated herein by reference in their entirety.

### TECHNICAL FIELD

The present disclosure relates to the communication field, and more particularly, to methods and devices for transmission configuration indicator (TCI) state indication and application.

### BACKGROUND

A New Radio (NR)/5G system generally supports multi-beam operation on downlink and uplink physical channels and reference signals. The use case for supporting multi-beam operation mainly is for deployment of a high-frequency band system, where high-gain analog beamforming is used to combat large path loss.

The 3GPP standards: 3GPP TS 38.211 V15.5.0: “NR; Physical channels and modulation”, 3GPP TS 38.212 V15.5.0: “NR; Multiplexing and channel coding”, 3GPP TS 38.213 V15.5.0: “NR; Physical layer procedures for control”, 3GPP TS 38.214 V15.5.0: “NR; Physical layer procedures for data”, 3GPP TS 38.215 V15.5.0: “NR; Physical layer measurements”, 3GPP TS 38.321 V15.5.0: “NR; Medium Access Control (MAC) protocol specification”, and 3GPP TS 38.331 V15.5.0: “NR; Radio Resource Control (RRC) protocol specification” disclose relevant background technologies.

### SUMMARY

Implementations of the present disclosure provide methods and devices for transmission configuration indicator (TCI) state indication and application.

In an aspect, a method for TCI state indication and application is provided. The method includes: receiving, by a terminal device, configuration of one or more TCI states from a network device; receiving, by the terminal device, indication of a TCI state through downlink control information (DCI) from the network device, wherein the indicated TCI state includes quasi co-location (QCL) information for downlink reception and includes information for determining a spatial filter and/or a path loss reference signal for uplink transmission; and applying, by the terminal device, the QCL information in the indicated TCI state to downlink reception and applying, by the terminal device, the information for determining a spatial filter and/or a path loss reference signal in the indicated TCI state to uplink transmission, starting from a pre-defined time point.

In another aspect, a method for TCI state indication and application is provided. The method includes: configuring, by a network device, one or more TCI states for a terminal device; and indicating, by the network device, a TCI state to the terminal device through a DCI, wherein the indicated TCI state includes QCL information for downlink reception and includes information for determining a spatial filter and/or a path loss reference signal for uplink transmission; wherein the QCL information in the indicated TCI state is to be applied to downlink reception and the information for determining a spatial filter and/or a path loss reference signal in the indicated TCI state is to be applied to uplink transmission, starting from a pre-defined time point.

In yet another aspect, a terminal device is provided. The terminal device includes a receiving module and a processing module, wherein the receiving module is configured to receive configuration of one or more TCI states from a network device; the receiving module is further configured to receive indication of a TCI state through a DCI from the network device, wherein the indicated TCI state includes QCL information for downlink reception and includes information for determining a spatial filter and/or a path loss reference signal for uplink transmission; the processing module is configured to apply the QCL information in the indicated TCI state to downlink reception and apply the information for determining a spatial filter and/or a path loss reference signal in the indicated TCI state to uplink transmission, starting from a pre-defined time point.

In yet another aspect, a network device is provided. The network device includes a transmitting module, wherein the transmitting module is configured to send configuration of one or more TCI states to a terminal device; the transmitting module is further configured to send indication of a TCI state to the terminal device through a DCI, wherein the indicated TCI state includes QCL information for downlink reception and includes information for determining a spatial filter and/or a path loss reference signal for uplink transmission; wherein the QCL information in the indicated TCI state is to be applied to downlink reception and the information for determining a spatial filter and/or a path loss reference signal in the indicated TCI state is to be applied to uplink transmission, starting from a pre-defined time point.

A better understanding of the nature and advantages of implementations of the present disclosure may be gained with reference to the following detailed description and the accompanying drawings.

### BRIEF DESCRIPTION OF THE DRAWINGS

FIG. 1 is a schematic diagram of an exemplary application scenario where an implementation of the present disclosure may be applied.

FIG. 2 is a schematic diagram of a method for TCI state indication and application according to an implementation of the present disclosure.

FIG. 3 is a schematic diagram of a method for TCI state indication and application according to an implementation of the present disclosure.

FIG. 4 is a schematic diagram of a terminal device according to an implementation of the present disclosure.

FIG. 5 is a schematic diagram of a network device according to an implementation of the present disclosure.

FIG. 6 is a schematic diagram of structure of a terminal device according to an exemplary implementation of the present disclosure.

FIG. 7 is a schematic diagram of structure of a network device according to an exemplary implementation of the present disclosure.

### DETAILED DESCRIPTION

The technical solutions of exemplary implementations of the present disclosure will be described below with reference to the accompanying drawings. It should be understood that the exemplary implementations are intended for better understanding of the technical solutions of the present disclosure, rather than limiting the scope of the application, and skilled artisans would understand that the exemplary implementations and features disclosed herein can be combined according to actual needs.

The acts shown in the flowchart of the accompanying drawings may be implemented at least in part by a computer system storing a set of computer-executable instructions. In addition, although a logical sequence is shown in the flowchart, in some cases the acts shown or described may be performed in a different sequence, or some acts may be not performed at all.

The technical solutions of the implementations of the present disclosure may be applied to various communication systems, such as a Global System of Mobile communication (GSM) system, a Code Division Multiple Access (CDMA) system, a Wideband Code Division Multiple Access (WCDMA) system, a General Packet Radio Service (GPRS) system, a long term evolution (LTE) system, a LTE Frequency Division Duplex (FDD) system, a LTE Time Division Duplex (TDD) system, a Universal Mobile Telecommunication System (UMTS) system, a Worldwide Interoperability for Microwave Access (WiMAX) communication system, a New Radio (NR) system or fifth-generation (5G) system, or a further communication system.

A terminal device in implementations of the present disclosure may refer to user equipment (UE), an access terminal, a subscriber unit, a subscriber station, a mobile station, a rover station, a remote station, a remote terminal, a mobile device, a user terminal, a terminal, a wireless communication device, a user agent, or a user device. The access terminal may be a cellular phone, a cordless phone, a session initiation protocol (SIP) phone, a wireless local loop (WLL) station, a personal digital assistant (PDA), a handheld device with a wireless communication function, a computing device or other processing devices connected to a wireless modem, an on-board device, a wearable device, a terminal device in a 5G network, or a terminal device in an evolved public land mobile network (PLMN), etc., which are not restricted in the implementations of the present disclosure.

A network device (e.g., a base station) in implementations of the present disclosure may be a device for communicating with a terminal device, and the network device may be a Base Transceiver Station (BTS) in the GSM or CDMA system, a NodeB (NB) in the WCDMA system, an evolved base station (eNB or eNodeB) in the LTE system, or a wireless controller in a Cloud Radio Access Network (CRAN) scenario, or the network device may be a relay station, an access point, an on-board device, a wearable device, a network device (e.g., gNB) in a 5G network, or a network device in an evolved PLMN, etc., which are not restricted in the implementations of the present invention.

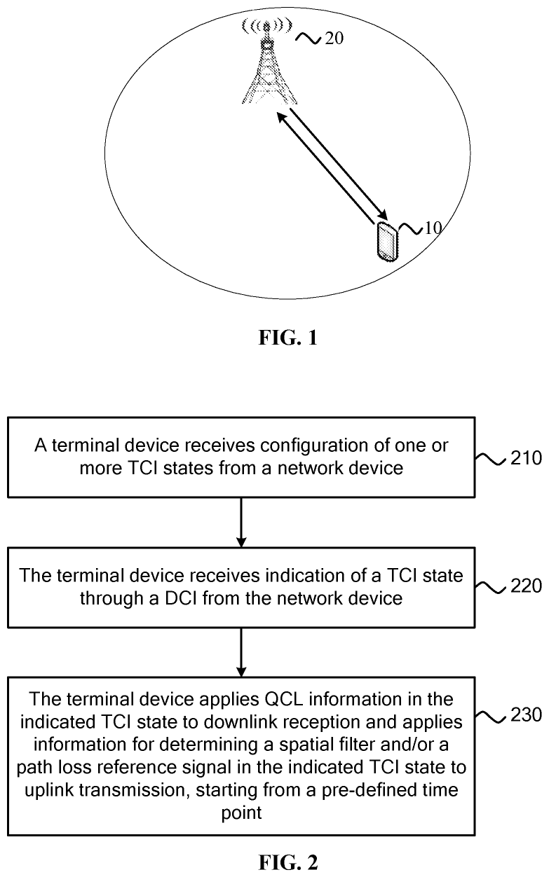

FIG. 1 shows a schematic diagram of an exemplary application scenario where an implementation of the present disclosure may be applied. A communication system shown in FIG. 1 may include a terminal device 10 and a network device 20. The network device 20 is configured to provide a communication service for the terminal device 10 and is connected to a core network (not shown). The terminal device 10 accesses the network by searching for a synchronization signal, or a broadcast signal, etc., transmitted by the network device 20 to communicate with the network. Arrows shown in FIG. 1 may indicate uplink/downlink transmission through cellular links between the terminal device 10 and the network device 20.

In some exemplary implementations of the present disclosure, a terminal device is described as a UE as an example, but skilled artisans should understand that the terminal device in the present disclosure is not limited to the UE, but can also be other types of terminal device as mentioned above.

NR release 15/16 supports the function of indicating a beam used for a channel such as a physical downlink control channel (PDCCH), a physical downlink shared channel (PDSCH), a physical uplink control channel (PUCCH), or a physical uplink shared channel (PUSCH), or a reference signal such as a channel state information reference signal (CSI-RS) or a sounding reference signal (SRS), through the framework of TCI-state for downlink transmission or spatial relation for uplink transmission.

For PDCCH and PDSCH, a UE may be configured with M TCI-states in higher layer signaling as candidate quasi co-location (QCL) configurations. For each control resource set (CORESET) for PDCCH transmission, the UE can be configured with one or more TCI-states semi-statically and if more than one TCI-state is configured, one MAC control element (CE) command is used to activate one of those TCI-states as the active transmit (Tx) beam for PDCCH transmission. For PDSCH, one MAC CE activation command can activate up to 8 TCI-states and each TCI-state is mapped to one codepoint in the downlink control information (DCI) scheduling PDSCH transmission. Then for each individual PDSCH transmission, the network (NW) can dynamically indicate one of those up to 8 TCI-states through the scheduling DCI.

The system can also use a single MAC CE to update/indicate TCI state(s) for PDCCH and PDSCH in multiple component carriers (CCs) simultaneously. Using a single MAC CE message to update TCI state(s) for PDCCH and PDSCH in multiple different CCs can reduce the overhead of control signaling. Particularly, the system can configure a list of cells for simultaneous TCI state for PDCCH and PDSCH. The system can send one MAC CE indicating one TCI state identity (Id) and one CORESET index, and the UE may apply the antenna port quasi co-location provided by the indicated TCI state to the CORESET with the indicated index of all the configured cells in the configured list. For PDSCH transmission, the system can send one MAC CE message that activates up to 8 TCI state Ids for PDSCH transmission and the UE may apply the indicated TCI state Ids on the PDSCH transmission in all the configured cells in the configured list. There are two special cases for determining the TCI state for a PDSCH transmission.

If a DCI does not contain a TCI field and the time offset between the PDSCH and the scheduling DCI is equal or greater than a threshold timeDurationForQCL, the TCI state applied to the CORESET used for the PDCCH transmission scheduling the PDSCH may be applied to the PDSCH transmission.

If a DCI does not contain a TCI field and the time offset between the PDSCH and the scheduling DCI is less than the threshold timeDurationForQCL, the UE would apply a ‘default’ TCI state on the PDSCH reception and the ‘default’ TCI state is the TCI state or QCL assumption of the CORESET with lowest controlResourceSetId in the latest slot in which one or more CORESETs within the active BWP of serving cell are monitored by the UE.

The Tx beam information for CSI-RS transmission is indicated through a TCI-state configured or indicated to a CSI-RS resource. For a periodic CSI-RS resource, the TCI-state is configured in RRC signaling semi-statically. For a semi-persistent CSI-RS resource, the TCI-state can be configured in RRC signaling semi-statically or indicated in the MAC CE message that activates the transmission of semi-persistent CSI-RS. For an aperiodic CSI-RS resource, the TCI-state is configured to the CSI-RS resource in the configuration of aperiodic CSI-RS trigger state in RRC signaling. Then the gNB can use physical layer signaling to dynamically trigger the transmission of aperiodic CSI-RS transmission and also dynamically indicate the Tx beam information.

For SRS transmission, a UE Tx beam is configured or indicated through spatial relation info. For periodic SRS transmission, the spatial relation info is configured per SRS resource in RRC signaling semi-statically. For aperiodic SRS transmission, the spatial relation info can be configured in RRC signaling semi-statically, which is one method and another method is the NW can use one MAC CE to update/indicate spatial relation info for an SRS resource, which thus provide more dynamic spatial relation info updating. For semi-persistent SRS transmission, the spatial relation info can be included in the MAC CE activation command that activates the transmission of semi-persistent SRS resource. To reduce the overhead of MAC CE for indicating spatial relation info for SRS, the system can use a single MAC CE to indicate one spatial relation info for SRS resources in multiple different cells. The UE can be provided with a list of CCs and a MAC CE can be used to indicate spatial relation info for all the SRS resource with a same resource Id in all the CCs included in the configured list.

For PUCCH transmission, a UE Tx beam is configured through PUCCH spatial relation info. The UE is provided with one or more than one PUCCH spatial relation info configuration in RRC signaling semi-statically. Then for each PUCCH resource, the UE can be indicated with one PUCCH spatial relation info through a MAC CE activation command. To reduce the overhead of MAC CE for indicating spatial relation info for PUCCH, the system can use a single MAC CE to indicate one spatial relation info for a group of PUCCH resources.

Furthermore, when the UE is not provided with spatial relation info to an SRS resource or PUCCH resource, the UE can apply a default spatial relation info on the SRS resource or PUCCH resource. The default spatial relation info is pre-specified as follows:

In a BWP where the UE is configured with any CORESET for PDCCH transmission, the default spatial relation info is the TCI state with the lowest controlResourceSetId.

In a BWP where the UE is not configured with any CORESET for PDCCH transmission, the default spatial relation info is the activated TCI state with lowest ID among the TCI states activated for PDSCH in the same BWP.

Currently used methods may have the following drawbacks:

Generally, the downlink and uplink transmission would use the same ‘best’ beam pair link. But the current method uses separate signaling to indicate the Tx beam for them. The consequence is signaling overhead is increased and thus latency of beam switch is increased.

The TCI-state for PDCCH and PDSCH is configured in each serving cell. In intra-band carrier aggregation (CA) scenario, the system would apply the same Tx beams on the transmission in all the cells but the current method requires to configure TCI-states in each cell and indicates the same TCI-state IDs for PDCCH and PDSCH in different serving cells. Even though the system can configure the same QCL-TypeD reference signal in the TCI states with the same ID in different serving cells by implementation so that the same Tx beam(s) is applied to the PDCCH and PDSCH in different serving cells, this would impose huge limitation on NW implementation. When to switch the Tx beam for PDCCH and PDSCH due to UE mobility, the NW would have to re-configure the TCI-states in all the serving cells, which increases the signaling overhead and increases the latency too.

The present disclosure provides methods and devices for overcoming the drawbacks of the current methods.

FIG. 2 is a schematic diagram of a method for TCI state indication and application according to an implementation of the present disclosure. As shown in FIG. 2, the method includes acts 210, 220 and 230. In act 210, a terminal device receives configuration of one or more TCI states from a network device. In act 220, the terminal device receives indication of a TCI state through a DCI from the network device, wherein the indicated TCI state includes QCL information for downlink reception and includes information for determining a spatial filter and/or a path loss reference signal for uplink transmission. In act 230, the terminal device applies the QCL information in the indicated TCI state to downlink reception and applies the information for determining a spatial filter and/or a path loss reference signal in the indicated TCI state to uplink transmission, starting from a pre-defined time point.

Herein, the downlink reception may include reception on at least one of: a PDSCH, a PDCCH or a CSI-RS resource, and the uplink transmission may include transmission on at least one of: a PUSCH, a PUCCH or a SRS resource.

In an exemplary implementation, each of the one or more TCI states includes one or more of following parameters: a reference signal configured for QCL-TypeD quasi co-location type; a reference signal for determining a spatial filter for uplink transmission; a reference signal configured for QCL-TypeD quasi co-location type and for determining a spatial filter for uplink transmission; a reference signal for determining a path loss reference signal for uplink transmission; or a reference signal configured for QCL-TypeD quasi co-location type and for determining a spatial filter and a path loss reference signal for uplink transmission.

For example, a UE can be configured with M higher layer parameters TCI state and in each TCI state, the UE can be provided with one or more of the following parameters:

One reference signal providing ‘QCL-TypeD’ quasi co-location type for quasi co-location relationship between one or two downlink reference signals and the demodulation reference signal (DM-RS) ports of the PDSCH, the DM-RS port of PDCCH or the CSI-RS port(s) of a CSI-RS resource.

One reference signal providing information for determining a spatial filter for the transmission of PUSCH, PUCCH or an SRS resource.

One reference signal providing both ‘QCL-TypeD’ for PDSCH, PDCCH or CSI-RS resource and a spatial filter for PUSCH, PUCCH or the SRS resource.

One reference signal proving a path loss reference signal for PUSCH, PUCCH or the SRS resource.

One reference signal providing both ‘QCL-TypeD’ for PDSCH, PDCCH or CSI-RS resource and a spatial filter and a path loss reference signal for PUSCH, PUCCH or the SRS resource.

In an exemplary implementation, the reference signal configured for QCL-TypeD quasi co-location type is a synchronization signal/physical broadcast channel (SS/PBCH) block, a CSI-RS resource, or an SRS resource. The reference signal for determining a spatial filter for uplink transmission is an SS/PBCH block, a CSI-RS resource or an SRS resource. The reference signal for determining a path loss reference signal for uplink transmission is an SS/PBCH block or a CSI-RS resource.

For example, an RS providing QCL assumption can be an SS/PBCH block, a CSI-RS resource or an SRS resource. An RS providing information for determining a spatial filter for PUSCH, PUCCH or SRS resource can be an SS/PBCH block, a CSI-RS resource or an SRS resource. An RS providing information of path loss RS for PUSCH, PUCCH or SRS resource can be an SS/PBCH block or a CSI-RS resource.

For a UE configured with common TCI state operation, the system can use DCI signaling to indicate a first TCI state to the UE. After the UE receives that DCI signaling, the UE can be requested to apply the QCL information provided by the first TCI state to receive PDCCH, PDSCH and CSI-RS resource and apply information of spatial filter and path loss RS provided by the first TCI state to transmit PUSCH, PUCCH and SRS resource starting from some pre-defined time point.

In an exemplary implementation, the DCI is of DCI format 1_1 or DCI format 1_2. A transmission configuration indication field of the DCI may be used to indicate a TCI state, wherein a value of the transmission configuration indication field may correspond to the indicated TCI state, and a value of the transmission configuration indication field may be used to indicate that no TCI state is indicated in the DCI. The terminal device may continue to use a TCI state indicated by a previous DCI when no TCI state is indicated in the DCI.

For example, when a UE is configured to operate in a common TCI state mode, DCI format 1_1 and DCI format 1_2 can be used to indicate one TCI state that the UE can be requested to apply on receiving PDCCH, PDSCH or CSI-RS resource and transmitting PUSCH, PUCCH or SRS resource in one CC.

When a UE receives a DCI format 1_1 or DCI format 1_2 carrying a DCI field Transmission configuration indication, the value of the DCI field Transmission configuration indication can indicate one TCI state for the UE. For example, the value of the DCI field Transmission configuration indication can correspond to one TCI state that is configured in higher layer parameter. The value of the DCI field Transmission configuration indication can correspond to one of the TCI states that are activated by a MAC CE command. One of the values of the DCI field Transmission configuration indication for example, 0, can indicate that no TCI state is indicated by the DCI format 1_1 or DCI format 1_2. In this case, the UE may continue to use the TCI state indicated by one previous DCI format 1_1 or DCI format 1_2.

In an exemplary implementation, the pre-defined time point refers to a first slot after N1 symbols from a last symbol of a PDCCH carrying the DCI, wherein N1 is a positive integer.

For example, for a UE configured with common TCI state operation mode, when the UE receives one DCI format 1_1 or DCI format 1_2 indicating one TCI state at slot n, the UE can be requested to apply the indicated TCI state for receiving PDCCH, PDSCH or CSI-RS resource and transmitting PUSCH, PUCCH or SRS resource starting from the first slot after N1 symbols from the last symbol of a PDCCH reception carrying the DCI format 1_1 or DCI format 1_2.

In an exemplary implementation, the method further includes: the terminal device sends, to the network device, acknowledgement information for a PDSCH scheduled by the DCI, and the pre-defined time point refers to a time point after N2 symbols from a last symbol of a PUCCH carrying the acknowledgement information, wherein N2 is a positive integer.

For example, for a UE configured with common TCI state operation mode, when the UE receives one DCI format 1_1 or DCI format 1_2 indicating one TCI state at slot n, the UE can be requested to send hybrid automatic repeat request acknowledge (HARQ-ACK) information corresponding to the PDSCH scheduled by the DCI format 1_1 or DCI format 1_2. After N2 symbols from the last symbol of the PUCCH carrying the HARQ-ACK information in response to the PDSCH scheduled by DCI format 1_1 or DCI format 1_2 indicating a TCI state, the UE can assume to apply the indicated TCI state for receiving PDCCH, PDSCH or CSI-RS resource and transmitting PUSCH, PUCCH or SRS resource.

In an exemplary implementation, the method further includes: the terminal device sends, to the network device, acknowledgement information for a PDSCH scheduled by the DCI, and the terminal device is configured with a dedicated search space for receiving a response from the network device for the acknowledgement information, and the pre-defined time point refers to a time point after N3 symbols from a last symbol of a PDCCH carrying the response in the dedicated search space, wherein N3 is a positive integer.

For example, a UE can be configured with a dedicated first search space (e.g., a dedicated first search space set) for receiving gNB response for the ACK of DCI format 1_1 or DCI format 1_2 indicating a TCI state for common TCI state operation. When the UE receives a DCI format 1_1 or 1_2 indicating a first TCI state at slot n and the UE sends an ACK for the PDSCH scheduled by the DCI format 1_1 or 1_2 at slot m, after the UE sends the ACK, the UE can start to monitor the dedicated first search space for a DCI format with a cyclic redundancy check (CRC) scrambled with a cell radio network temporary identity (C-RNTI) or a modulation coding scheme cell radio network temporary identity (MCS-C-RNTI). After N3 symbols from the last symbol of a PDCCH reception in the dedicated first search space set for which the UE detects a DCI format with CRC scrambled by C-RNTI or MCS-C-RNTI, the UE can assume to apply the indicated first TCI state in the DCI format 1_1 or 1_2 for receiving PDCCH, PDSCH or CSI-RS resource and transmitting PUSCH, PUCCH or SRS resource.

In an exemplary implementation, the method further includes: the terminal device sends, to the network device, first acknowledgement information for a PDSCH scheduled by the DCI, and the terminal device is configured with a dedicated search space for receiving a response from the network device for the acknowledgement information. The method further includes: the terminal device sends, to the network device, second acknowledgement information for a PDSCH scheduled by a PDCCH carrying the response in the dedicated search space. The pre-defined time point refers to a time point after N4 symbols from a last symbol of a PUCCH carrying the second acknowledgement information, wherein N4 is a positive integer.

For example, a UE can be configured with a dedicated first search space (e.g., a dedicated first search space set) for receiving gNB response for the ACK of DCI format 1_1 or 1_2. When the UE receives a DCI format 1_1 or 1_2 indicating a first TCI state at slot n and the UE sends an ACK for the PDSCH scheduled by the DCI format 1_1 or 1_2 at slot m, after the UE sends the ACK, the UE can start to monitor the dedicated first search space for a DCI format with CRC scrambled with C-RNTI or MCS-C-RNTI. Then the UE may send HARQ-ACK for the PDSCH scheduled by the DCI format. After N4 symbols from the last symbol of the PUCCH carrying the HARQ-ACK information in response to the PDSCH scheduled by a PDCCH reception in the dedicated first search space set for which the UE detects the DCI format with CRC scrambled by C-RNTI or MCS-C-RNTI, the UE can assume to apply the indicated first TCI state in the DCI format 1_1 or 1_2 for receiving PDCCH, PDSCH or CSI-RS resource and transmitting PUSCH, PUCCH or SRS resource.

In an exemplary implementation, the DCI is of a DCI format including: a field of a TCI state Id; a field of an Id of a TCI state for control channels and a field of an Id of a TCI state for data channels and reference signals; or a field of an Id of a first TCI state and a field of an Id of a second TCI state. Herein, the control channels include a PDCCH and a PUCCH, the data channels include a PDSCH and a PUSCH, and the reference signals include a CSI-RS and a SRS. The first TCI state is to be applied to reception on a PDCCH, PDSCH and/or CSI-RS resource that is associated with a first value of a higher layer parameter and transmission on a PUSCH, PUCCH and/or SRS resource that is associated with the first value of the higher layer parameter. The second TCI state is to be applied to reception on a PDCCH, PDSCH and/or CSI-RS resource that is associated with a second value of the higher layer parameter and transmission on a PUSCH, PUCCH and/or SRS resource that is associated with the second value of the higher layer parameter.

In an exemplary implementation, the DCI format further includes one or more of following fields: an identifier for DCI formats, a carrier indicator, a bandwidth part indicator, a PUCCH resource indicator, a transmit power control (TPC) command for scheduled PUCCH, or a physical downlink control channel to hybrid automatic repeat request (PDCCH-to-HARQ) feedback timing indicator.

For example, a DCI format X1 is used by the system to indicate a TCI state to a UE. The DCI format X1 is used for indicating a TCI state to a UE.

In one example, one or more of the following information is transmitted by means of DCI format X1 with CRC scrambled by C-RNTI:
Identifier for DCI formats
Carrier indicator
Bandwidth part indicator
PUCCH resource indicator
TPC command for scheduled PUCCH
PDCCH-to-HARQ feedback timing indicator
TCI state Id.

In one example, one or more of the following information is transmitted by means of DCI format X1 with CRC scrambled by C-RNTI:
Identifier for DCI formats
Carrier indicator
Bandwidth part indicator
PUCCH resource indicator
TPC command for scheduled PUCCH
PDCCH-to-HARQ feedback timing indicator
Id of TCI state for PDCCH and PUCCH
Id of TCI state for PDSCH, PUSCH, CSI-RS and SRS.

Herein, the DCI field “Id of TCI state for PDCCH and PUCCH” can indicate one TCI state that the UE is requested to apply on receiving PDCCH and transmitting PUCCH. The DCI field “Id of TCI state for PDSCH, PUSCH, CSI-RS and SRS” can indicate one TCI state that the UE is requested to apply on receiving PDSCH and CSI-RS resource and transmitting PUSCH and SRS resource.

In one example, one or more of the following information is transmitted by means of DCI format X1 with CRC scrambled by C-RNTI:
Identifier for DCI formats
Carrier indicator
Bandwidth part indicator
PUCCH resource indicator
TPC command for scheduled PUCCH
PDCCH-to-HARQ feedback timing indicator
Id of a first TCI state
Id of a second TCI state.

Herein, the DL channels, CSI-RS resources, UL channels and SRS resource can be associated with a value of a higher layer parameter. The DCI field “Id of a first TCI state” can indicate one TCI state that the UE is requested to apply on receiving PDCCH, PDSCH or CSI-RS resource that is associated with a first value of the higher layer parameter and transmitting PUSCH, PUCCH or SRS resource that is associated with a first value of the higher layer parameter. The DCI field “Id of a second TCI state” can indicate one TCI state that the UE is requested to apply on receiving PDCCH, PDSCH or CSI-RS resource that is associated with a second value of the higher layer parameter and transmitting PUSCH, PUCCH or SRS resource that is associated with a second value of the higher layer parameter.

In an exemplary implementation, the method further includes: the terminal device sends, to the network device, acknowledgement information for the DCI when the terminal device receives the DCI. Herein, the terminal device sends the acknowledgement information after N5 symbols from a last symbol of a PDCCH carrying the DCI, wherein N5 is a positive integer; and/or the terminal device sends the acknowledgement information in a PUCCH determined by a PUCCH resource indicator and a PDCCH-to-HARQ feedback timing indicator in the DCI.

For example, when a UE receives a DCI format X1, the UE is expected to provide HARQ-ACK information in response to the DCI format X1. The UE can determine the PUCCH resource for transmitting the HARQ-ACK information in response to the DCI format X1 according to one or more of the following example methods.

In one example, the UE can be expected to provide HARQ-ACK information in response to the DCI format X1 after N5 symbols from the last symbol of a PDCCH providing the DCI format X1. For example, If processingType2Enabled of PDSCH-ServingCellConfig is set to enable for the serving cell with the PDCCH providing the DCI format X1, N5=5 for μ=0, N5=5.5 for μ=1, and N5.11 for μ=2, otherwise, N5.10 for μ=0, N5=12 for μ=1, N5=22 for μ=2, and N5=25 for μ=3, wherein p corresponds to the smallest subcarrier spacing (SCS) configuration between the SCS configuration of the PDCCH providing the DCI format X1 and the SCS configuration of a PUCCH carrying the HARQ-ACK information in response to a DCI format X1.

In one example, the UE can be expected to provide HARQ-ACK information in response to the DCI format X1 in the PUCCH transmission determined by the PUCCH resource indicator and PDCCH-to-HARQ feedback timing indicator provided in the DCI format X1.

In an exemplary implementation, the pre-defined time point refers to a first slot after k1 slots from a slot when the terminal device sends the acknowledgement information, wherein k1 is a positive integer.

In an exemplary implementation, the pre-defined time point refers to a first slot after a slot when the terminal device sends the acknowledgement information.

In an exemplary implementation, the terminal device is configured with a dedicated search space for receiving a response from the network device for the acknowledgement information, and the pre-defined time point refers to a time point after N6 symbols from a last symbol of a PDCCH carrying the response in the dedicated search space, wherein N6 is a positive integer.

In an exemplary implementation, the acknowledgement information sent by the terminal device for the DCI is first acknowledgement information, and the terminal device is configured with a dedicated search space for receiving a response from the network device for the first acknowledgement information. The method further includes: the terminal device sends, to the network device, second acknowledgement information for a PDSCH scheduled by a PDCCH carrying the response in the dedicated search space. The pre-defined time point refers to a time point after N7 symbols from a last symbol of a PUCCH carrying the second acknowledgement information, wherein N7 is a positive integer.

For example, the DCI field TCI state Id in DCI format X1 can be used to indicate one of the M higher layer parameters TCI state. When a UE receives a DCI format X1 indicating a first TCI state, the UE can be requested to apply the first TCI state on reception of downlink (DL) transmission and transmission of uplink (UL) channels/signals according to one or more of the following example methods.

In one example, the UE receives a DCI format X1 indicating a first TCI state at slot n and the UE sends an ACK for the DCI format X1 at slot m. The UE may apply the first TCI state for receiving DL channels/signals and transmitting UL channels/signals starting from the first slot that is after slot m+k1. Example value of k1 can be 1, 2, 3, 4, 5.

In one example, the UE receives a DCI format X1 indicating a first TCI state at slot n and the UE sends an ACK for the DCI format X1 at slot m. The UE may apply the first TCI state for receiving DL channels/signals and transmitting UL channels/signals starting from the first slot that is after slot m.

In one example, the UE can be configured with a dedicated first search space (e.g., a dedicated first search space set) for receiving gNB response for the ACK of DCI format X1. When the UE receives a DCI format X1 indicating a first TCI state at slot n and the UE sends an ACK for the DCI format X1 at slot m, after the UE sends the ACK for DCI format X1, the UE can start to monitor the dedicated first search space for a DCI format with CRC scrambled with C-RNTI or MCS-C-RNTI. After N6 symbols from the last symbol of a PDCCH reception in the dedicated first search space set for which the UE detects a DCI format with CRC scrambled by C-RNTI or MCS-C-RNTI, the UE can assume to apply the indicated first TCI state in the DCI format X1 for receiving DL channels/signals and transmitting UL channels/signals.

In one example, the UE can be configured with a dedicated first search space (e.g., a dedicated first search space set) for receiving gNB response for the ACK of DCI format X1. When the UE receives a DCI format X1 indicating a first TCI state at slot n and the UE sends an ACK for the DCI format X1 at slot m. After the UE sends ACK for DCI format X1, the UE can start to monitor the dedicated first search space for a DCI format with CRC scrambled with C-RNTI or MCS-C-RNTI. Then the UE may send HARQ-ACK for the PDSCH scheduled by the DCI format. After N7 symbols from the last symbol of the PUCCH carrying the HARQ-ACK information in response to the PDSCH scheduled by a PDCCH reception in the dedicated first search space set for which the UE detects the DCI format with CRC scrambled by C-RNTI or MCS-C-RNTI, the UE can assume to apply the indicated first TCI state in the DCI format X1 for receiving DL channels/signals and transmitting UL channels/signals.

In an exemplary implementation, the DCI is of a DCI format for indicating one or more TCI states for one or more terminal devices respectively. Herein, the DCI format includes N blocks, and each of the N blocks is used to indicate a TCI state for a terminal device, wherein N is a positive integer, and a starting position and a length of a block are configured, through high layer parameters, for a terminal device configured with the block. The DCI format may be transmitted with a CRC scrambled with a TCI state radio network temporary identity (TCI-State-RNTI). The pre-defined time point may refer to a first slot after N8 symbols from a last symbol of a PDCCH carrying the DCI, wherein N8 is a positive integer.

For example, a DCI format Y1 is used to indicate TCI state(s) for one or more UEs. The DCI format Y1 can be transmitted with CRC scrambled with TCI-State-RNTI. The following information can be transmitted by means of DCI format Y1 with CRC scrambled with TCI-State-RNTI: block number 1, block number 2, . . . , block number N; where the starting position and length of a block can be configured through higher layer parameters for the UE configured with the block.

In one example, a block number i can be used to indicate one TCI state for a UE:

The starting position of block number i can be configured through a higher layer parameter for the UE configured with this block.

The length (i.e., number of bits) of block number i can be configured through a higher layer parameter for the UE configured with this block.

The length (i.e., number of bits) of block number i can be determined as [log₂ M] where M is the number of TCI states configured to the UE configured with this block.

In one example, one special value of block number i can be defined as that no TCI state is indicated for the corresponding UE. For example, when the value of block number i is all 0s, the UE can assume no TCI state is indicated by the block number i.

When a UE receives a DCI format Y1 at slot n, the UE can derive a TCI state according to the value indicated in block number i that the UE is configured with. the UE can be requested to apply the indicated TCI state for receiving PDCCH, PDSCH or CSI-RS resource and transmitting PUSCH, PUCCH or SRS resource starting from the first slot after N8 symbols from the last symbol of a PDCCH reception carrying the DCI format Y1.

As can be seen, various exemplary implementations are provided in the present disclosure for common TCI state based multi-beam operation. When a UE is configured with a common TCI state operation mode, the UE can receive a DCI that indicates one TCI state at slot n and starting from a pre-specified time point, the UE can be requested to apply the QCL assumption to receive PDCCH, PDSCH and/or CSI-RS resource and the UE can be requested to apply spatial filter and/or path loss on transmitting PUSCH, PUCCH and/or SRS resource. For example, in one method, the ‘Transmission configuration indication’ in DCI format 1_1 or DCI format 1_2 can indicate one TCI state for DL reception and UL transmission. The UE may apply the QCL information, spatial setting and/or path loss RS provided by the TCI state starting from k1 slots (or k2 milliseconds) after the UE sends the HARQ-ACK corresponding to the PDSCH scheduled by DCI format. In one method, a DCI format X1 can indicate an Id of TCI state configured in higher layer and the UE may send an ACK if the UE decodes that DCI format X1 correctly. The UE may apply the QCL information, spatial setting and/or path loss RS provided by the TCI state starting from k1 slots (or k2 milliseconds) after the UE sends the HARQ-ACK corresponding to the reception of the DCI format X1. In one method, a DCI format Y1 can indicate N TCI state Ids and each indicated TCI state Id is for one UE. The UE may apply the QCL information, spatial setting and/or path loss RS provided by the TCI state starting from k1 slots or symbols (or k2 milliseconds) after the UE receives the DCI format Y1. Herein, the k1 and k2 are positive integers.

FIG. 3 is a schematic diagram of a method for TCI state indication and application according to an implementation of the present disclosure. As shown in FIG. 3, the method includes acts 310 and 320. In act 310, a network device configures one or more TCI states for a terminal device. In act 320, the network device indicates a TCI state to the terminal device through a DCI. Herein, the indicated TCI state includes QCL information for downlink reception and includes information for determining a spatial filter and/or a path loss reference signal for uplink transmission. The QCL information in the indicated TCI state is to be applied to downlink reception and the information for determining a spatial filter and/or a path loss reference signal in the indicated TCI state is to be applied to uplink transmission, starting from a pre-defined time point.

In an exemplary implementation, each of the one or more TCI states includes one or more of following parameters: a reference signal configured for QCL-TypeD quasi co-location type; a reference signal for determining a spatial filter for uplink transmission; a reference signal configured for QCL-TypeD quasi co-location type and for determining a spatial filter for uplink transmission; a reference signal for determining a path loss reference signal for uplink transmission; or a reference signal configured for QCL-TypeD quasi co-location type and for determining a spatial filter and a path loss reference signal for uplink transmission.

In an exemplary implementation, the reference signal configured for QCL-TypeD quasi co-location type is a SS/PBCH block, a CSI-RS resource, or a SRS resource; the reference signal for determining a spatial filter for uplink transmission is an SS/PBCH block, a CSI-RS resource or an SRS resource; the reference signal for determining a path loss reference signal for uplink transmission is an SS/PBCH block or a CSI-RS resource.

In an exemplary implementation, the downlink reception includes reception on at least one of: a PDSCH, a PDCCH or a CSI-RS resource, and the uplink transmission includes transmission on at least one of: a PUSCH, a PUCCH or a SRS resource.

In an exemplary implementation, the pre-defined time point refers to a first slot after N1 symbols from a last symbol of a PDCCH carrying the DCI, wherein N1 is a positive integer.

In an exemplary implementation, the method further includes: the network device receives, from the terminal device, acknowledgement information for a PDSCH scheduled by the DCI. The pre-defined time point refers to a time point after N2 symbols from a last symbol of a PUCCH carrying the acknowledgement information, wherein N2 is a positive integer.

In an exemplary implementation, the method further includes: the network device receives, from the terminal device, acknowledgement information for a PDSCH scheduled by the DCI; and the network device sends a response for the acknowledgement information through a PDCCH in a dedicated search space configured for the terminal device. The pre-defined time point refers to a time point after N3 symbols from a last symbol of the PDCCH carrying the response in the dedicated search space, wherein N3 is a positive integer.

In an exemplary implementation, the method further includes: the network device receives, from the terminal device, first acknowledgement information for a PDSCH scheduled by the DCI; the network device sends a response for the first acknowledgement information through a PDCCH in a dedicated search space configured for the terminal device; and the network device receives, from the terminal device, second acknowledgement information for a PDSCH scheduled by the PDCCH carrying the response in the dedicated search space. The pre-defined time point refers to a time point after N4 symbols from a last symbol of a PUCCH carrying the second acknowledgement information, wherein N4 is a positive integer.

In an exemplary implementation, the DCI is of DCI format 1_1 or DCI format 1_2. A transmission configuration indication field of the DCI can be used to indicate a TCI state, and a value of the transmission configuration indication field can correspond to the indicated TCI state. A value of the transmission configuration indication field can be used to indicate that no TCI state is indicated in the DCI, and a TCI state indicated by a previous DCI can be used when no TCI state is indicated in the DCI.

In an exemplary implementation, the DCI is of a DCI format including: a field of a TCI state Id; a field of an Id of a TCI state for control channels and a field of an Id of a TCI state for data channels and reference signals; or a field of an Id of a first TCI state and a field of an Id of a second TCI state. Herein, the control channels include a PDCCH and a PUCCH, the data channels include a PDSCH and a PUSCH, and the reference signals include a CSI-RS and a SRS. The first TCI state is to be applied to reception on a PDCCH, PDSCH and/or CSI-RS resource that is associated with a first value of a higher layer parameter and transmission on a PUSCH, PUCCH and/or SRS resource that is associated with the first value of the higher layer parameter; the second TCI state is to be applied to reception on a PDCCH, PDSCH and/or CSI-RS resource that is associated with a second value of the higher layer parameter and transmission on a PUSCH, PUCCH and/or SRS resource that is associated with the second value of the higher layer parameter.

In an exemplary implementation, the DCI format further includes one or more of following fields: an identifier for DCI formats; a carrier indicator; a bandwidth part indicator; a PUCCH resource indicator; a TPC command for scheduled PUCCH; or a PDCCH-to-HARQ feedback timing indicator.

In an exemplary implementation, the method further includes: the network device receives acknowledgement information for the DCI sent by the terminal device.

In an exemplary implementation, the acknowledgement information is sent after N5 symbols from a last symbol of a PDCCH carrying the DCI, wherein N5 is a positive integer; and/or the acknowledgement information is sent through a PUCCH determined by a PUCCH resource indicator and a PDCCH-to-HARQ feedback timing indicator in the DCI.

In an exemplary implementation, the pre-defined time point refers to a first slot after k1 slots from a slot when the acknowledgement information is sent, wherein k1 is a positive integer.

In an exemplary implementation, the pre-defined time point refers to a first slot after a slot when the acknowledgement information is sent.

In an exemplary implementation, the method further includes: the network device sends a response for the acknowledgement information through a PDCCH in a dedicated search space configured for the terminal device. The pre-defined time point refers to a time point after N6 symbols from a last symbol of the PDCCH carrying the response in the dedicated search space, wherein N6 is a positive integer.

In an exemplary implementation, the acknowledgement information sent by the terminal device for the DCI is first acknowledgement information. The method further includes: the network device sends a response for the first acknowledgement information through a PDCCH in a dedicated search space configured for the terminal device; and the network device receives, from the terminal device, second acknowledgement information for a PDSCH scheduled by the PDCCH carrying the response in the dedicated search space. The pre-defined time point refers to a time point after N7 symbols from a last symbol of a PUCCH carrying the second acknowledgement information, wherein N7 is a positive integer.

In an exemplary implementation, the DCI is of a DCI format for indicating one or more TCI states for one or more terminal devices respectively. The DCI format includes N blocks, and each of the N blocks is used to indicate a TCI state for a terminal device, wherein N is a positive integer, and a starting position and a length of a block are configured, through high layer parameters, for a terminal device configured with the block. The DCI format is transmitted with a CRC scrambled with a TCI-State-RNTI. The pre-defined time point refers to a first slot after N8 symbols from a last symbol of a PDCCH carrying the DCI, wherein N8 is a positive integer.

Herein, it should be understood that the method of FIG. 3 corresponds to the method of FIG. 2, and relevant implementation details and examples of the method of FIG. 3 are similar as those described above for the method of FIG. 2, and will not be repeated here for conciseness of the present disclosure.

FIG. 4 shows a schematic diagram of a terminal device 400 according to an implementation of the present disclosure. As shown in FIG. 4, the terminal device 400 includes a receiving module 410 and a processing module 420. The receiving module 410 is configured to receive configuration of one or more TCI states from a network device. The receiving module 410 is further configured to receive indication of a TCI state through a DCI from the network device, wherein the indicated TCI state includes QCL information for downlink reception and includes information for determining a spatial filter and/or a path loss reference signal for uplink transmission. The processing module 420 is configured to apply the QCL information in the indicated TCI state to downlink reception and apply the information for determining a spatial filter and/or a path loss reference signal in the indicated TCI state to uplink transmission, starting from a pre-defined time point.

In an exemplary implementation, each of the one or more TCI states includes one or more of following parameters: a reference signal configured for QCL-TypeD quasi co-location type; a reference signal for determining a spatial filter for uplink transmission; a reference signal configured for QCL-TypeD quasi co-location type and for determining a spatial filter for uplink transmission; a reference signal for determining a path loss reference signal for uplink transmission; or a reference signal configured for QCL-TypeD quasi co-location type and for determining a spatial filter and a path loss reference signal for uplink transmission.

In an exemplary implementation, the reference signal configured for QCL-TypeD quasi co-location type is a SS/PBCH block, a CSI-RS resource, or a SRS resource; the reference signal for determining a spatial filter for uplink transmission is an SS/PBCH block, a CSI-RS resource or an SRS resource; the reference signal for determining a path loss reference signal for uplink transmission is an SS/PBCH block or a CSI-RS resource.

In an exemplary implementation, the downlink reception includes reception on at least one of: a PDSCH, a PDCCH or a CSI-RS resource, and the uplink transmission includes transmission on at least one of: a PUSCH, a PUCCH or a SRS resource.

In an exemplary implementation, the pre-defined time point refers to a first slot after N1 symbols from a last symbol of a PDCCH carrying the DCI, wherein N1 is a positive integer.

In an exemplary implementation, the terminal device 400 further includes a transmitting module 430 configured to send, to the network device, acknowledgement information for a PDSCH scheduled by the DCI. The pre-defined time point refers to a time point after N2 symbols from a last symbol of a PUCCH carrying the acknowledgement information, wherein N2 is a positive integer.

In an exemplary implementation, the terminal device 400 further includes a transmitting module 430 configured to send, to the network device, acknowledgement information for a PDSCH scheduled by the DCI. The terminal device 400 is configured with a dedicated search space for receiving a response from the network device for the acknowledgement information. The pre-defined time point refers to a time point after N3 symbols from a last symbol of a PDCCH carrying the response in the dedicated search space, wherein N3 is a positive integer.

In an exemplary implementation, the terminal device 400 further includes a transmitting module 430 configured to send, to the network device, first acknowledgement information for a PDSCH scheduled by the DCI. The terminal device 400 is configured with a dedicated search space for receiving a response from the network device for the first acknowledgement information. The transmitting module 430 is further configured to send, to the network device, second acknowledgement information for a PDSCH scheduled by a PDCCH carrying the response in the dedicated search space. The pre-defined time point refers to a time point after N4 symbols from a last symbol of a PUCCH carrying the second acknowledgement information, wherein N4 is a positive integer.

In an exemplary implementation, the DCI is of DCI format 1_1 or DCI format 1_2. A transmission configuration indication field of the DCI can be used to indicate a TCI state, and a value of the transmission configuration indication field can correspond to the indicated TCI state. A value of the transmission configuration indication field can be used to indicate that no TCI state is indicated in the DCI. The processing module 420 is configured to use a TCI state indicated by a previous DCI when no TCI state is indicated in the DCI.

In an exemplary implementation, the DCI is of a DCI format including: a field of a TCI state Id; a field of an Id of a TCI state for control channels and a field of an Id of a TCI state for data channels and reference signals; or a field of an Id of a first TCI state and a field of an Id of a second TCI state. Herein, the control channels include a PDCCH and a PUCCH, the data channels include a PDSCH and a PUSCH, and the reference signals include a CSI-RS and a SRS. The first TCI state is to be applied to reception on a PDCCH, PDSCH and/or CSI-RS resource that is associated with a first value of a higher layer parameter and transmission on a PUSCH, PUCCH and/or SRS resource that is associated with the first value of the higher layer parameter; the second TCI state is to be applied to reception on a PDCCH, PDSCH and/or CSI-RS resource that is associated with a second value of the higher layer parameter and transmission on a PUSCH, PUCCH and/or SRS resource that is associated with the second value of the higher layer parameter.

In an exemplary implementation, the DCI format further includes one or more of following fields: an identifier for DCI formats; a carrier indicator; a bandwidth part indicator; a PUCCH resource indicator; a TPC command for scheduled PUCCH; or a PDCCH-to-HARQ feedback timing indicator.

In an exemplary implementation, the terminal device 400 further includes a transmitting module 430 configured to send, to the network device, acknowledgement information for the DCI when the receiving module 410 receives the DCI.

In an exemplary implementation, the transmitting module 430 is configured to send the acknowledgement information after N5 symbols from a last symbol of a PDCCH carrying the DCI, wherein N5 is a positive integer; and/or the transmitting module 430 is configured to send the acknowledgement information in a PUCCH determined by a PUCCH resource indicator and a PDCCH-to-HARQ feedback timing indicator in the DCI.

In an exemplary implementation, the pre-defined time point refers to a first slot after k1 slots from a slot when the transmitting module 430 sends the acknowledgement information, wherein k1 is a positive integer.

In an exemplary implementation, the pre-defined time point refers to a first slot after a slot when the transmitting module 430 sends the acknowledgement information.

In an exemplary implementation, the terminal device 400 is configured with a dedicated search space for receiving a response from the network device for the acknowledgement information, and the pre-defined time point refers to a time point after N6 symbols from a last symbol of a PDCCH carrying the response in the dedicated search space, wherein N6 is a positive integer.

In an exemplary implementation, the acknowledgement information sent by the transmitting module 430 for the DCI is first acknowledgement information. The terminal device 400 is configured with a dedicated search space for receiving a response from the network device for the first acknowledgement information. The transmitting module 430 is configured to send, to the network device, second acknowledgement information for a PDSCH scheduled by a PDCCH carrying the response in the dedicated search space. The pre-defined time point refers to a time point after N7 symbols from a last symbol of a PUCCH carrying the second acknowledgement information, wherein N7 is a positive integer.

In an exemplary implementation, the DCI is of a DCI format for indicating one or more TCI states for one or more terminal devices respectively. The DCI format includes N blocks, and each of the N blocks is used to indicate a TCI state for a terminal device, wherein N is a positive integer. A starting position and a length of a block are configured, through high layer parameters, for a terminal device configured with the block. The DCI format is transmitted with a CRC scrambled with a TCI-State-RNTI. The pre-defined time point refers to a first slot after N8 symbols from a last symbol of a PDCCH carrying the DCI, wherein N8 is a positive integer.

It should be understood that the terminal device 400 in the above exemplary implementations can be the terminal device in the various implementations and examples relating to the method of FIG. 2, and the operations and/or functions of the terminal device 400 are respectively for the purpose of implementing corresponding acts of the terminal device in the various method implementations relating to FIG. 2, and accordingly, relevant details and examples can be similar as those described above for the method implementations relating to FIG. 2 and will not be repeated here for conciseness of the present disclosure.

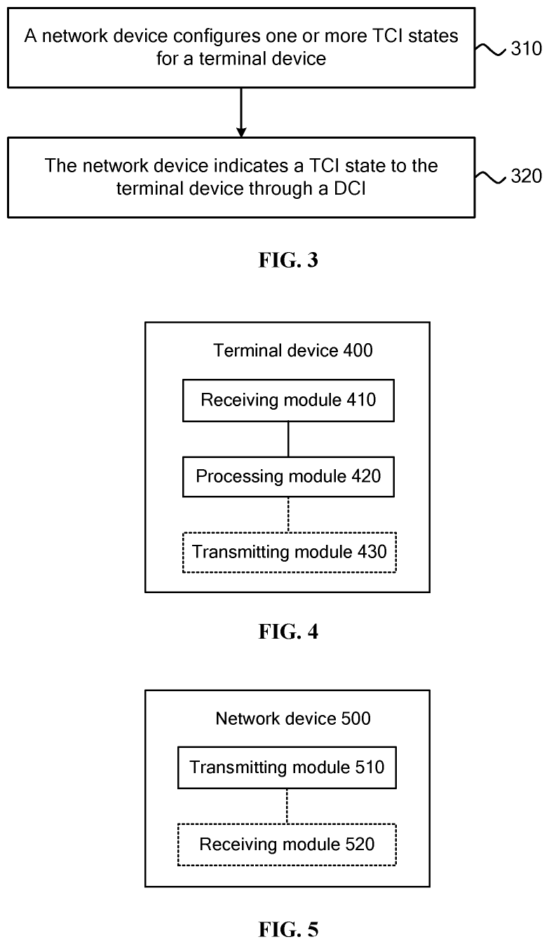

FIG. 5 shows a schematic diagram of a network device 500 according to an implementation of the present disclosure. As shown in FIG. 5, the network device 500 includes a transmitting module 510. The transmitting module 510 is configured to send configuration of one or more TCI states to a terminal device. The transmitting module 510 is further configured to send indication of a TCI state to the terminal device through a DCI, wherein the indicated TCI state includes QCL information for downlink reception and includes information for determining a spatial filter and/or a path loss reference signal for uplink transmission. The QCL information in the indicated TCI state is to be applied to downlink reception and the information for determining a spatial filter and/or a path loss reference signal in the indicated TCI state is to be applied to uplink transmission, starting from a pre-defined time point.

In an exemplary implementation, each of the one or more TCI states includes one or more of following parameters: a reference signal configured for QCL-TypeD quasi co-location type; a reference signal for determining a spatial filter for uplink transmission; a reference signal configured for QCL-TypeD quasi co-location type and for determining a spatial filter for uplink transmission; a reference signal for determining a path loss reference signal for uplink transmission; or a reference signal configured for QCL-TypeD quasi co-location type and for determining a spatial filter and a path loss reference signal for uplink transmission.

In an exemplary implementation, the reference signal configured for QCL-TypeD quasi co-location type is a SS/PBCH block, a CSI-RS resource, or a SRS resource; the reference signal for determining a spatial filter for uplink transmission is an SS/PBCH block, a CSI-RS resource or an SRS resource; the reference signal for determining a path loss reference signal for uplink transmission is an SS/PBCH block or a CSI-RS resource.

In an exemplary implementation, the downlink reception includes reception on at least one of: a PDSCH, a PDCCH or a CSI-RS resource, and the uplink transmission includes transmission on at least one of: a PUSCH, a PUCCH or a SRS resource.

In an exemplary implementation, the pre-defined time point refers to a first slot after N1 symbols from a last symbol of a PDCCH carrying the DCI, wherein N1 is a positive integer.

In an exemplary implementation, the network device 500 further includes a receiving module 520 configured to receive, from the terminal device, acknowledgement information for a PDSCH scheduled by the DCI. The pre-defined time point refers to a time point after N2 symbols from a last symbol of a PUCCH carrying the acknowledgement information, wherein N2 is a positive integer.

In an exemplary implementation, the network device 500 further includes a receiving module 520 configured to receive, from the terminal device, acknowledgement information for a PDSCH scheduled by the DCI. The transmitting module 510 is further configured to send a response for the acknowledgement information through a PDCCH in a dedicated search space configured for the terminal device. The pre-defined time point refers to a time point after N3 symbols from a last symbol of the PDCCH carrying the response in the dedicated search space, wherein N3 is a positive integer.

In an exemplary implementation, the network device 500 further includes a receiving module 520 configured to receive, from the terminal device, first acknowledgement information for a PDSCH scheduled by the DCI. The transmitting module 510 is further configured to send a response for the first acknowledgement information through a PDCCH in a dedicated search space configured for the terminal device. The receiving module 520 is further configured to receive, from the terminal device, second acknowledgement information for a PDSCH scheduled by the PDCCH carrying the response in the dedicated search space. The pre-defined time point refers to a time point after N4 symbols from a last symbol of a PUCCH carrying the second acknowledgement information, wherein N4 is a positive integer.

In an exemplary implementation, the DCI is of DCI format 1_1 or DCI format 1_2. A transmission configuration indication field of the DCI can be used to indicate a TCI state, and a value of the transmission configuration indication field can correspond to the indicated TCI state. A value of the transmission configuration indication field can be used to indicate that no TCI state is indicated in the DCI, and a TCI state indicated by a previous DCI can be used when no TCI state is indicated in the DCI.

In an exemplary implementation, the DCI is of a DCI format including: a field of a TCI state Id; a field of an Id of a TCI state for control channels and a field of an Id of a TCI state for data channels and reference signals; or a field of an Id of a first TCI state and a field of an Id of a second TCI state. Herein, the control channels include a PDCCH and a PUCCH, the data channels include a PDSCH and a PUSCH, and the reference signals include a CSI-RS and a SRS. The first TCI state is to be applied to reception on a PDCCH, PDSCH and/or CSI-RS resource that is associated with a first value of a higher layer parameter and transmission on a PUSCH, PUCCH and/or SRS resource that is associated with the first value of the higher layer parameter; the second TCI state is to be applied to reception on a PDCCH, PDSCH and/or CSI-RS resource that is associated with a second value of the higher layer parameter and transmission on a PUSCH, PUCCH and/or SRS resource that is associated with the second value of the higher layer parameter.

In an exemplary implementation, the DCI format further includes one or more of following fields: an identifier for DCI formats; a carrier indicator; a bandwidth part indicator; a PUCCH resource indicator; a TPC command for scheduled PUCCH; or a PDCCH-to-HARQ feedback timing indicator.

In an exemplary implementation, the network device 500 further includes a receiving module 520 configured to receive acknowledgement information for the DCI sent by the terminal device.

In an exemplary implementation, the acknowledgement information is sent after N5 symbols from a last symbol of a PDCCH carrying the DCI, wherein N5 is a positive integer; and/or the acknowledgement information is sent through a PUCCH determined by a PUCCH resource indicator and a PDCCH-to-HARQ feedback timing indicator in the DCI.

In an exemplary implementation, the pre-defined time point refers to a first slot after k1 slots from a slot when the acknowledgement information is sent, wherein k1 is a positive integer.

In an exemplary implementation, the pre-defined time point refers to a first slot after a slot when the acknowledgement information is sent.

In an exemplary implementation, the transmitting module 510 is further configured to send a response for the acknowledgement information through a PDCCH in a dedicated search space configured for the terminal device. The pre-defined time point refers to a time point after N6 symbols from a last symbol of the PDCCH carrying the response in the dedicated search space, wherein N6 is a positive integer.

In an exemplary implementation, the acknowledgement information sent by the terminal device for the DCI is first acknowledgement information. The transmitting module 510 is further configured to send a response for the first acknowledgement information through a PDCCH in a dedicated search space configured for the terminal device. The receiving module 520 is further configured to receive second acknowledgement information for a PDSCH scheduled by the PDCCH carrying the response in the dedicated search space. The pre-defined time point refers to a time point after N7 symbols from a last symbol of a PUCCH carrying the second acknowledgement information, wherein N7 is a positive integer.

In an exemplary implementation, the DCI is of a DCI format for indicating one or more TCI states for one or more terminal devices respectively. The DCI format includes N blocks, and each of the N blocks is used to indicate a TCI state for a terminal device, wherein N is a positive integer, and a starting position and a length of a block are configured, through high layer parameters, for a terminal device configured with the block. The DCI format is transmitted with a CRC scrambled with a TCI-State-RNTI. The pre-defined time point refers to a first slot after N8 symbols from a last symbol of a PDCCH carrying the DCI, wherein N8 is a positive integer.

It should be understood that the network device 500 in the above exemplary implementations can be the network device in the various implementations and examples relating to the methods of FIG. 2 and FIG. 3, and the operations and/or functions of the network device 500 are respectively for the purpose of implementing corresponding acts of the network device in the various method implementations relating to FIG. 2 and FIG. 3, and accordingly, relevant details and examples can be similar as those described above for the method implementations relating to FIG. 2 and FIG. 3 and will not be repeated here for conciseness of the present disclosure.

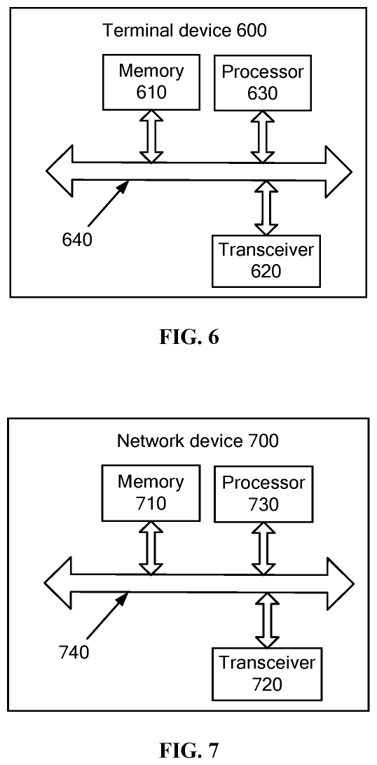

FIG. 6 shows a schematic diagram of structure of a terminal device 600 according to an exemplary implementation of the present disclosure. As shown in FIG. 6, the terminal device 600 may include a memory 610, a transceiver 620, and a processor 630. The memory 610 may be configured to store data and/or information. The memory 610 may be further configured to store instructions executable by the processor 630, and the processor 630 may be configured to execute the instructions stored in the memory 610 to control the transceiver 620 to receive and/or send signals. Particularly, the transceiver 620 may be configured to implement the functions/operations of the aforementioned receiving module 410 and transmitting module 430. The processor 630 may be configured to implement the functions/operations of the aforementioned processing module 420. Functions/operations of the receiving module 410, processing module 420, and transmitting module 430 are already described in the above and will not be repeated here for conciseness of the present disclosure. The terminal device 600 may further include a bus system 640, which may be configured to connect the components, such as the memory 610, the transceiver 620, and the processor 630, of the terminal device 600.

Herein, it should be understood that the memory 610 may include a read only memory and a random access memory, and may provide instructions and data to the processor 630. A portion of the memory 610 may further include a non-volatile random access memory. For example, the memory 610 may further store device type information and/or other information.

The processor 630 may be a central processing unit (CPU) or other general-purpose processor, a digital signal processor (DSP), an application specific integrated circuit (ASIC), an off-the-shelf programmable gate array (FPGA) or other programmable logic device, a discrete gate or a transistor logic device, or a discrete hardware component, etc. The general-purpose processor may be a microprocessor or any conventional processor.

The bus system 640 may include, in addition to a data bus, a power bus, a control bus, a status signal bus, etc. However, for the sake of clarity, various buses are illustrated as the bus system 640 in FIG. 6.

The various acts of the terminal device in the exemplary implementations relating to the method of FIG. 2 may be implemented by instructions of software or integrated logic circuits of hardware or combination of software and hardware. The software modules may be located in a typical storage medium in the art such as a random access memory, a flash memory, a read-only memory, a programmable read-only memory, an electrically erasable programmable memory, a register, etc. The storage medium may be located in the memory 610, and the processor 630 may read the information in the memory 610 and control the transceiver 620 to send and/or receive signals.

It should be understood that the terminal device 600 can be the terminal device in the various implementations and examples relating to the method of FIG. 2. The terminal device 600 may implement corresponding acts of the terminal device in the various method implementations relating to FIG. 2, and accordingly, relevant details and examples can be similar as those described above for the method implementations relating to FIG. 2 and will not be repeated here for conciseness of the present disclosure.

FIG. 7 shows a schematic diagram of structure of a network device 700 according to an exemplary implementation of the present disclosure. As shown in FIG. 7, the network device 700 may include a memory 710, a transceiver 720, and a processor 730. The memory 710 may be configured to store instructions executable by the processor 730, and the processor 730 may be configured to execute the instructions stored in the memory 710 to control the transceiver 720 to receive and/or send signals. Particularly, the transceiver 720 may be configured to implement the functions/operations of the aforementioned transmitting module 510 and receiving module 520. Functions/operations of the transmitting module 510 and receiving module 520 are already described in the above and will not be repeated here for conciseness of the present disclosure. The network device 700 may further include a bus system 740, which may be configured to connect the components, such as the memory 710, the transceiver 720, and the processor 730, of the network device 700.

Herein, it should be understood that the memory 710 may include a read only memory and a random access memory, and may provide instructions and data to the processor 730. A portion of the memory 710 may further include a non-volatile random access memory. For example, the memory 710 may further store device type information and/or other information.

The processor 730 may be a central processing unit (CPU) or other general-purpose processor, a digital signal processor (DSP), an application specific integrated circuit (ASIC), an off-the-shelf programmable gate array (FPGA) or other programmable logic device, a discrete gate or a transistor logic device, or a discrete hardware component, etc. The general-purpose processor may be a microprocessor or any conventional processor.

The bus system 740 may include, in addition to a data bus, a power bus, a control bus, a status signal bus, etc. However, for the sake of clarity, various buses are illustrated as the bus system 740 in FIG. 7.

The various acts of the network device in the exemplary implementations relating to the methods of FIG. 2 and FIG. 3 may be implemented by instructions of software or integrated logic circuits of hardware or combination of software and hardware. The software modules may be located in a typical storage medium in the art such as a random access memory, a flash memory, a read-only memory, a programmable read-only memory, an electrically erasable programmable memory, a register, etc. The storage medium may be located in the memory 710, and the processor 730 may read the information in the memory 710 and control the transceiver 720 to send and/or receive signals.

It should be understood that the network device 700 can be the network device in the various implementations and examples relating to the methods of FIG. 2 and FIG. 3. The network device 700 may implement corresponding acts of the network device in the various method implementations relating to FIG. 2 and FIG. 3, and accordingly, relevant details and examples can be similar as those described above for the method implementations relating to FIG. 2 and FIG. 3 and will not be repeated here for conciseness of the present disclosure.

Further, a computer readable storage medium is provided in the present disclosure. The computer readable storage medium may store instructions that are executable by a computer or processor to implement any of the aforementioned method for TCI state indication and application and/or any exemplary implementation thereof.

It should be understood that in various implementations of the present disclosure, the term “and/or” is used to describe an association relationship between associated objects, indicating that there may be three relationships, for example, A and/or B may indicate three situations: A alone, A and B, and B alone. In addition, the symbol “/” in the present disclosure generally indicates that objects of the former and the latter connected by “/” has an “or” relationship.

Those skilled in the art should understand that the elements and acts in the various implementations disclosed herein may be implemented in electronic hardware, computer software, or a combination of the electronic hardware and the computer software. In order to clearly illustrate the interchangeability of hardware and software, the composition and acts in the implementations have been described in general terms by functions in the above description. Whether these functions are performed in hardware or software depends on the specific application and design constraints of the technical solution. Skilled artisans may use different methods to implement the described functions for each particular application, but such implementation should not be considered to be beyond the scope of the present disclosure.

Those skilled in the art should understand that the specific working processes of the devices and modules described above may correspond to the corresponding processes in the method implementations and may not be repeated for convenience and conciseness of description.

In various implementations of the present disclosure, it should be understood that the disclosed methods and devices may be implemented in other ways. For example, the device implementations described above are merely illustrative, the division of modules is only a logical function division, and there may be other ways of division in actual implementations. For example, multiple modules or components may be combined or integrated into another system, or some features may be ignored or not executed. In addition, the coupling or communication connection between the elements shown or discussed may be a direct coupling or indirect coupling, or communication connection through some interface, device or unit, or may be an electrical, mechanical or other form of connection.

The components described as separate components may be or may be not physically separated, and the component may be or may be not a physical component, i.e., it may be located in one place or may be distributed over multiple network units. Some or all of the components may be selected according to actual needs to achieve the purpose of the implementations of the present disclosure.

The modules may be stored in a computer readable storage medium if they are implemented in the form of software function modules and sold or used as an independent product. Based on such understanding, the technical solutions of the present disclosure may be embodied in the form of a software product, which is stored in a storage medium and includes instructions for causing a computer device (which may be a personal computer, a server, a terminal device, or a network device, etc.) to perform all or part of the acts of the method in various implementations of the present disclosure. The storage media may include a U disk, a mobile hard disk, a read-only memory, a random access memory, a magnetic disk, an optical disk, or other media capable of storing program codes.

What are described above are merely exemplary implementations of the present disclosure. Although the exemplary implementations have been described in considerable detail above, numerous variations and modifications will become apparent to those skilled in the art once the above disclosure is fully appreciated. It is intended that the following claims be interpreted to embrace all such variations and modifications.

1. A method for transmission configuration indicator (TCI) state indication and application, comprising:
receiving, by a terminal device, configuration of one or more TCI states from a network device;
receiving, by the terminal device, indication of a TCI state through downlink control information (DCI) from the network device, wherein the indicated TCI state comprises quasi co-location (QCL) information for downlink reception and comprises information for determining a spatial filter and/or a path loss reference signal for uplink transmission; and
applying, by the terminal device, the QCL information in the indicated TCI state to downlink reception and applying, by the terminal device, the information for determining a spatial filter and/or a path loss reference signal in the indicated TCI state to uplink transmission, starting from a pre-defined time point.

2. The method of claim 1, wherein each of the one or more TCI states comprises one or more of following parameters:
a reference signal configured for QCL-TypeD quasi co-location type;
a reference signal for determining a spatial filter for uplink transmission;
a reference signal configured for QCL-TypeD quasi co-location type and for determining a spatial filter for uplink transmission;
a reference signal for determining a path loss reference signal for uplink transmission; or
a reference signal configured for QCL-TypeD quasi co-location type and for determining a spatial filter and a path loss reference signal for uplink transmission.

3. The method of claim 2, wherein the reference signal configured for QCL-TypeD quasi co-location type is a synchronization signal/physical broadcast channel (SS/PBCH) block, a channel state information reference signal (CSI-RS) resource, or a sounding reference signal (SRS) resource;
the reference signal for determining a spatial filter for uplink transmission is an SS/PBCH block, a CSI-RS resource or an SRS resource;
the reference signal for determining a path loss reference signal for uplink transmission is an SS/PBCH block or a CSI-RS resource.

4. The method of claim 1, wherein the downlink reception comprises reception on at least one of: a physical downlink shared channel (PDSCH), a physical downlink control channel (PDCCH) or a channel state information reference signal (CSI-RS) resource, and the uplink transmission comprises transmission on at least one of: a physical uplink shared channel (PUSCH), a physical uplink control channel (PUCCH) or a sounding reference signal (SRS) resource.

5. The method of claim 1, wherein the pre-defined time point refers to a first slot after N1 symbols from a last symbol of a physical downlink control channel (PDCCH) carrying the DCI, wherein N1 is a positive integer.

6. The method of claim 1, further comprising:
sending, by the terminal device to the network device, acknowledgement information for a physical downlink shared channel (PDSCH) scheduled by the DCI;
wherein the pre-defined time point refers to a time point after N2 symbols from a last symbol of a physical uplink control channel (PUCCH) carrying the acknowledgement information, wherein N2 is a positive integer.

7. The method of claim 1, wherein the DCI is of DCI format 1_1 or DCI format 1_2.

8. The method of claim 7, wherein a transmission configuration indication field of the DCI is used to indicate a TCI state, and a value of the transmission configuration indication field corresponds to the indicated TCI state.

9. A terminal device, comprising: a transceiver and a processor, wherein
the transceiver is configured to receive configuration of one or more transmission configuration indicator (TCI) states from a network device;
the transceiver is further configured to receive indication of a TCI state through downlink control information (DCI) from the network device, wherein the indicated TCI state comprises quasi co-location (QCL) information for downlink reception and comprises information for determining a spatial filter and/or a path loss reference signal for uplink transmission;
the processor is configured to apply the QCL information in the indicated TCI state to downlink reception and apply the information for determining a spatial filter and/or a path loss reference signal in the indicated TCI state to uplink transmission, starting from a pre-defined time point.

10. The terminal device of claim 9, wherein each of the one or more TCI states comprises one or more of following parameters:
a reference signal configured for QCL-TypeD quasi co-location type;
a reference signal for determining a spatial filter for uplink transmission;
a reference signal configured for QCL-TypeD quasi co-location type and for determining a spatial filter for uplink transmission;
a reference signal for determining a path loss reference signal for uplink transmission; or
a reference signal configured for QCL-TypeD quasi co-location type and for determining a spatial filter and a path loss reference signal for uplink transmission.

11. The terminal device of claim 10, wherein the reference signal configured for QCL-TypeD quasi co-location type is a synchronization signal/physical broadcast channel (SS/PBCH) block, a channel state information reference signal (CSI-RS) resource, or a sounding reference signal (SRS) resource;
the reference signal for determining a spatial filter for uplink transmission is an SS/PBCH block, a CSI-RS resource or an SRS resource;
the reference signal for determining a path loss reference signal for uplink transmission is an SS/PBCH block or a CSI-RS resource.

12. The terminal device of claim 9, wherein the downlink reception comprises reception on at least one of: a physical downlink shared channel (PDSCH), a physical downlink control channel (PDCCH) or a channel state information reference signal (CSI-RS) resource, and the uplink transmission comprises transmission on at least one of: a physical uplink shared channel (PUSCH), a physical uplink control channel (PUCCH) or a sounding reference signal (SRS) resource.

13. The terminal device of claim 9, wherein the pre-defined time point refers to a first slot after N1 symbols from a last symbol of a physical downlink control channel (PDCCH) carrying the DCI, wherein N1 is a positive integer; or
the transceiver is configured to send, to the network device, acknowledgement information for a physical downlink shared channel (PDSCH) scheduled by the DCI; wherein the pre-defined time point refers to a time point after N2 symbols from a last symbol of a physical uplink control channel (PUCCH) carrying the acknowledgement information, wherein N2 is a positive integer.

14. The terminal device of claim 9, wherein the DCI is of DCI format 1_1 or DCI format 1_2; and
a transmission configuration indication field of the DCI is used to indicate a TCI state, and a value of the transmission configuration indication field corresponds to the indicated TCI state.

15. A network device, comprising: a transceiver, wherein
the transceiver is configured to send configuration of one or more transmission configuration indicator (TCI) states to a terminal device;
the transceiver is further configured to send indication of a TCI state to the terminal device through downlink control information (DCI), wherein the indicated TCI state comprises quasi co-location (QCL) information for downlink reception and comprises information for determining a spatial filter and/or a path loss reference signal for uplink transmission;
wherein the QCL information in the indicated TCI state is to be applied to downlink reception and the information for determining a spatial filter and/or a path loss reference signal in the indicated TCI state is to be applied to uplink transmission, starting from a pre-defined time point.

16. The network device of claim 15, wherein each of the one or more TCI states comprises one or more of following parameters:
a reference signal configured for QCL-TypeD quasi co-location type;
a reference signal for determining a spatial filter for uplink transmission;
a reference signal configured for QCL-TypeD quasi co-location type and for determining a spatial filter for uplink transmission;
a reference signal for determining a path loss reference signal for uplink transmission; or
a reference signal configured for QCL-TypeD quasi co-location type and for determining a spatial filter and a path loss reference signal for uplink transmission.

17. The network device of claim 16, wherein the reference signal configured for QCL-TypeD quasi co-location type is a synchronization signal/physical broadcast channel (SS/PBCH) block, a channel state information reference signal (CSI-RS) resource, or a sounding reference signal (SRS) resource;
the reference signal for determining a spatial filter for uplink transmission is an SS/PBCH block, a CSI-RS resource or an SRS resource;
the reference signal for determining a path loss reference signal for uplink transmission is an SS/PBCH block or a CSI-RS resource.

18. The network device of claim 15, wherein the downlink reception comprises reception on at least one of: a physical downlink shared channel (PDSCH), a physical downlink control channel (PDCCH) or a channel state information reference signal (CSI-RS) resource, and the uplink transmission comprises transmission on at least one of: a physical uplink shared channel (PUSCH), a physical uplink control channel (PUCCH) or a sounding reference signal (SRS) resource.

19. The network device of claim 15, wherein the pre-defined time point refers to a first slot after N1 symbols from a last symbol of a physical downlink control channel (PDCCH) carrying the DCI, wherein N1 is a positive integer; or
the transceiver is configured to receive, from the terminal device, acknowledgement information for a physical downlink shared channel (PDSCH) scheduled by the DCI; wherein the pre-defined time point refers to a time point after N2 symbols from a last symbol of a physical uplink control channel (PUCCH) carrying the acknowledgement information, wherein N2 is a positive integer.

20. The network device of claim 15, wherein the DCI is of DCI format 1_1 or DCI format 1_2; and
a transmission configuration indication field of the DCI is used to indicate a TCI state, and a value of the transmission configuration indication field corresponds to the indicated TCI state.
